(19) United States
(12) Patent Application Publication
(10) Pub. No.: US 2007/0005940 A1
(43) Pub. Date: Jan. 4, 2007

(54) System, apparatus and method of executing a micro operation

(76) Inventors: Zeev Sperber, Zichron Yaakov (IL); Guillermo Savransky, Haifa (IL); Sagi Lahav, Kiryat Motzkin (IL); Thierry Pons, Hadera (IL); Stephan Jourdan, Portland, OR (US)

Correspondence Address: PEARL COHEN ZEDEK LATZER, LLP, 1500 BROADWAY, 12TH FLOOR, NEW YORK, NY, 10036, US

(21) Appl. No.: 11/170,076

(22) Filed: Jun. 30, 2005

(51) Int. Cl. G06F 9/30

(52) U.S. Cl. 712/217

(57) ABSTRACT

Embodiments of the present invention provide an apparatus, system, and method of routing a source operand. Some demonstrative embodiments my include replacing a source operand of a micro operation to be executed by an execution unit with a value type representing a source value, e.g., if the source operand corresponds to the source value. Other embodiments are described and claimed.

### BACKGROUND OF TE INVENTION

Processors may be used for executing one or more macroinstructions. The processor may include one or more execution units (EUs).

A processor having a plurality of execution units (EUs) may include an Out-Of-Order (OOO) subsystem to use the EUs in an efficient manner. The OOO subsystem may include an Instruction Decoder (ID) to decode a macroinstruction to be executed by the processor into one or more micro-operations (“u-ops”) to be executed by the OOO subsystem. The OOO subsystem may enable more than one u-op to be executed at the same time, although the u-ops may be executed in a different order than the order in which they were received by the OOO subsystem.

The OOO subsystem may also include a reservation station (RS) to dispatch the u-ops to the different EUs. The RS may store a u-op and source operands to be used for executing the u-op. The RS may transfer the source operands and the u-op to an EU intended to execute the u-op, e.g., when the EU is available, and upon completely receiving the source operands. The EU may execute the u-op using the source operands received from the RS.

A relatively large amount of power may be consumed by the OOO subsystem, e.g., for storing the source operands in the RS, for retrieving the source operands from the RS, and/or for transferring the source operands from the RS to the EU.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a computing platform including a processor core in accordance with some demonstrative embodiments of the invention;

FIG. 2 is a schematic illustration of a processor core in accordance with some demonstrative embodiments of the invention; and

FIG. 3 is a schematic block diagram illustration of a method of executing a micro-operation in accordance with some demonstrative embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

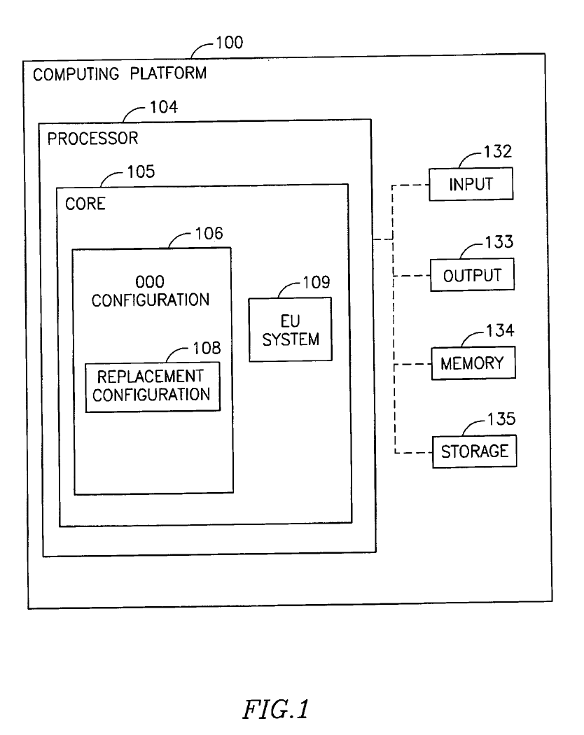

Reference is made to FIG. 1, which schematically illustrates a computing platform 100 in accordance with some demonstrative embodiments of the invention.

In some embodiments of the invention, computing platform 100 may include or may be a portable computing platform, which may be, for example, powered by a portable power source, e.g., a battery. In other embodiments of the invention, computing platform 100 may include or may be a non-portable computing platform.

Although the invention is not limited in this respect, platform 100 may include or may be, for example, a personal computer, a desktop computer, a mobile computer, a laptop computer, a notebook computer, a terminal, a workstation, a server computer, a Personal Digital Assistant (PDA) device, a tablet computer, a network device, a micro-controller, a cellular phone, a camera, or any other suitable computing and/or communication device.

According to some exemplary embodiments, platform 100 may include a processor 104. Processor 104 may include, for example, a Central Processing Unit (CPU), a Digital Signal Processor (DSP), a microprocessor, a host processor, a plurality of processors, a controller, a chip, a microchip, or any other suitable multi-purpose or specific processor or controller.

According to some demonstrative embodiments of the invention, processor 104 may include a processor core 105 able to receive one or more macro-instructions, decode the macro instructions into micro operations, and execute the micro operations. Design considerations, such as, but not limited to, processor performance, cost and power consumption, may result in a particular design of processor core 105. Although the scope of the present invention is not limited in this respect, processor core 105 may be designed for out-of-order (OOO) execution of micro operations. For example, processor core 105 may be capable of executing micro operations according to availability of source operands and/or execution resources within processor core 105, e.g., not necessarily according to the order in which the micro operations were decoded from the macro-instructions. In some cases, a micro operation generated fiom a particular macro-instruction may be executed after a micro operation generated from a later macro-instruction.

According to some demonstrative embodiments of the invention, processor core 105 may include an execution system 109 including at least one Execution Unit (EU). Processor core 105 may also include an OOO processor configuration 106 including a replacement configuration 108 able to selectively replace a source operand of a micro operation to be provided to execution system 109 with a value type representing a source value, e.g., if the source operand corresponds to the source value, as described in detail below Execution system 109 may be able to select from a set of one or more stored source values a stored source value corresponding to the value type; and to execute the micro-operation intended to operate on the source operand by operating the micro operation on the stored source value, e.g., as described in detail below.

According to some demonstrative embodiments of the invention, platform 100 may also include an input unit 132, an output unit 133, a memory unit 134, and/or a storage unit 135. Platform 100 may additionally include other suitable hardware components and/or software components.

Input unit 132 may include, for example, a keyboard, a mouse, a touch-pad, or other suitable pointing device or input device. Output unit 133 may include, for example, a Cathode Ray Tube (CRT) monitor, a Liquid Crystal Display (LCD) monitor, or other suitable monitor or display unit.

Storage unit 135 may include, for example, a hard disk drive, a floppy disk drive, a Compact Disk (CD) drive, a CD-Recordable (CD-R) drive, or other suitable removable and/or fixed storage unit.

Memory unit 134 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units. Memory unit 134 may be able to store, for example, one or more values corresponding to the micro operation intended to be executed by execution system 109.

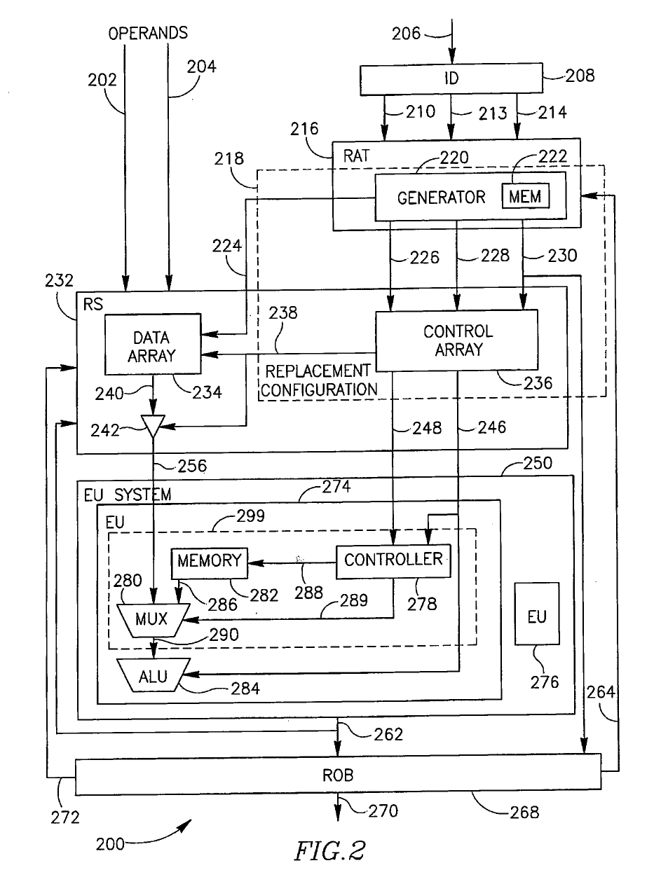

Reference is made to FIG. 2., which schematically illustrates a processor core 200 in accordance with some demonstrative embodiments of the invention.

Although the invention is not limited in this respect, processor core 200 may perform the functionality of processor core 105 (FIG. 1).

Processor core 200 may receive, e.g., from memory 134 (FIG. 1.) or from any other source, a plurality of macro instructions to be executed by processor core 200. Processor core 200 may execute the macro-instructions in order, i.e., in the same order the macro instructions were received by processor core 200. Alternatively, processor core 200 may execute the macro instructions out of order, i.e., in an order different than the order the macro instructions were received by processor core 200. Processor core 200 may also produce, for example, results of the macro-instruction in the same order the macro instructions were received by processor core 200.

According to some demonstrative embodiments of the invention, processor core 200 may include a macro Instruction Decoder (ID) 208, a Register Alias Table (RAT) 216, a Reservation Station (RS) 232, an execution system 250 including a plurality of EUs, e.g., EUs 274 and 276, and a Reorder Buffer (ROB) 268, as are described in detail below.

According to some demonstrative embodiments of the invention, ID 208 may receive a macro-instruction 206, for example, from memory 134 (FIG. 1) or from any other source, e.g., as known in the art ID 208 may decode macro-instruction 206 into one or more micro operations, e.g., depending upon a type of macro-instruction 206 as is known in the art. ID 208 may decode, for example, a macro-instruction into a plurality of micro operations of different types, each to be executed by a corresponding type of EU. A micro operation may include an operation to be executed by one of the EUs in execution system 250, with relation to one or more source operands, e.g., operands 202 and/or 204. Operands 202 and/or 204 may be received by RS 232, for example, from a front-end of processor core 200, from ROB 268, or from execution system 250, e.g., as is known in the art ID 208 may generate, for example, an operation code (“op-code”) signal 210 representing the type of operation to be performed on the source operands. ID 208 may also generate signals 213 indicating a width of the source operands, and/or signals 214 indicating the type of EU intended to execute the micro operation, e.g., as is known in the art.

According to some demonstrative embodiments of the invention, RAT 216 may receive signals 210, 213, and/or 214 corresponding to one or more micro operations, e.g, in the same order the micro operations were generated by ID 208. RAT 216 may determine which of the EUs of execution system 250 is to execute a micro operation corresponding to the op-code of signal 210, e.g., as is known in the art. RAT 216 may also provide RS 232 and ROB 268 with signals 230 corresponding to the op-code and to the source operand width indicated by signals 210 and 213, e.g., as is known in the art. RAT 216 may also provide RS 232 with signals 228 indicating a selected EU intended to execute the micro operation, e.g., as is known in the art.

According to some demonstrative embodiments of the invention, RS 232 may store and/or handle more than one micro operation at a time. RS 232 may include a data array 234 able to store one or more source operands corresponding to the one or more micro operations generated by ID 208, e.g., as is known in the art.

According to some demonstrative embodiments of the invention, RS 232 may controllably provide an EU of system 250, e.g., EU 274, with an op-code and/or one or more source operands corresponding to a micro operation, e.g., as described below.

According to some demonstrative embodiments of the invention, processor core 200 may include a replacement configuration 218 able to replace a source operand, e.g., source operand 202 and/or source operand 204, of a micro operation to be executed by execution system 250 with a value type representing a source value, e.g., if the source operand corresponds to the source value, as described in detail below. According to some demonstrative embodiments, if the source operand corresponds to the source value, then RS 232 may store the value type, e.g., instead of storing the source operand, as described below.

According to one demonstrative embodiments of the invention, some micro-operations may include an operation (“a single source operation”) relating to only one source operand. For example, a micro operation may include a move operation, a root operation, a shifting operation, e.g., wherein the operation relates to shift count data, or any other desired operation to be operated on a single source operand. Accordingly, replacement configuration 218 may controllably provide execution system 250 with the single source operand, and with a value type corresponding to a source operand having a zero value, e.g., instead of providing execution system 250 with a source operand having a zero value.

According to another demonstrative embodiment of the invention, some micro operations may relate to one or more source operands having predetermined source values. For example, a micro operation may relate to one or more source operands having a zero source value, or any other predetermined source value, e.g., a source value represented by a byte including a plurality of bits, each having the value one. In one example, the micro operation may include an addressing operation, e.g., relating to base, index and/or displacement operands. In some cases one or more of the base, index and/or displacement operands may have a zero value. Accordingly, replacement configuration 218 may controllably provide execution system 250 with one or more value types representing one or more source values, respectively, e.g., instead of providing execution system 250 with one or more source operands corresponding to the one or more source values.

According to some demonstrative embodiments of the invention, replacement configuration 218 may include a value type generator 220, and a control array 236, as are described below.

According to some demonstrative embodiments of the invention, generator 220 may generate a value type 226 representing a source value, e.g., if a source operand, e.g, source operand 202 and/or 204, corresponds to the source value.

According to some demonstrative embodiments of the invention, generator 220 may include any suitable hardware and/or software configuration able to select value type 226 from a set of one or more value types representing a set of source values. In some demonstrative embodiments of the invention, generator 220 may include a memory 222, e.g., a Look UP Table (LUT), to store the set of one or more value types.

According to some demonstrative embodiments of the invention, generator 220 may also be able to control the storing in data array 234 of one or more source operands related to op-code 210, e.g, operand 202 and/or 204, based on whether one or more of the source operands correspond to one or more values of the set of source values, as described below.

According to some exemplary embodiments of the invention, operands 204 and/or 202 may be selectively stored in data array 234; and/or one or more value types representing the value of source operands 204 and/or 202 may be stored by control array 236. For example, a source operand received by RS 232 may be stored in data array 234, e.g., if the source operand does not correspond to any one of the set of source values. Conversely, if the source operand corresponds to a source value of the set of source values, then a value type representing the source value, may be stored in control array 236, as described below.

According to some demonstrative embodiments of the invention, generator 220 may selectively generate a write enable signal 224, e.g., based on whether a source operand received by RS 232 corresponds to a value of the set of source values. In one example, source operand 204 corresponds to a first source value of the set of source values, and source operand 202 does not correspond to any one of the set of source values. Accordingly, generator 220 may provide data array 234 with write enable signal 224, e.g., only when source operand 202 is received by RS 232, such that source operand 202 is stored in data array 234 and source operand 204 is not stored in data array 234. In another example, neither one of source operand 204 and source operand 202 may correspond to any one of the set of source values. Accordingly, generator 220 may provide data array 234 with write enable signal 224, e.g., both when source operand 202 is received by RS 232 and when source operand 204 is received by RS 232 , such that both source operand 204 and source operand 202 are stored in data array 234. In another example, each of source operands 202 and 204 may correspond to a value of the set of source values. Accordingly, generator may not provide data array 234 with write enable signal 224, e.g., when source operands 202 and 204 are received by RS 232, such that neither one of source operands 202 and 204 is stored in data array 234.

According to some demonstrative embodiments of the invention, if a source operand, e.g., source operand 204, corresponds to a value of the set of source values, then generator 220 may provide control array 236 with value type 226 representing the source operand, e.g., instead of storing source operand 204 in data array 234. In addition, control array may maintain a value type identifier identifying value type 226 as valid. Conversely, if a source operand, e.g., source operand 204, does not correspond to any one of the set of source values, then generator 220 may control data array 234, e.g., using write enable signal 224, to store source operand 204. In addition, control array may maintain a source operand identifier identifying source operand 204 as valid.

According to some demonstrative embodiments of the invention, control array 236 may store the op-code, the EU information and the operand width information of signals 228 and 230, for example, until an EU of EU system 250 intended to execute the micro operation is available, and the source operands required for execution of the op-code, e.g., operands 204 and/or 202, have been received by RS 232.

According to some demonstrative embodiments of the invention, RS 232 may selectively provide an EU of system 250, e.g., EU 274, with signals 256 representing one or more source operands retrieved from data array 234, signals 248 representing one or more value types corresponding to one or more of the source operands received by RS 232, and/or signals 246 including an op-code to be operated on one or more source values represented by the source operands and/or value types. For example, RS 232 may generate signals 246 representing an op-code of a micro-operation, signals 256 representing one or more source operands, and/or signals 246 representing one or more value types, e.g., after all source values of the micro operation are identified as valid by the source identifiers and/or type identifiers, as described below.

According to some demonstrative embodiments of the invention, RS 232 may include a driver 242 to controllably retrieve one or more source operands 240 from data array 234, e.g., as is known in the art. Control array 236 may control driver 242 using a read enable control signal 238, e.g., when transferring to EU system 250 (“dispatching”) signals 246 of a micro operation to be executed by system 250. For example, control array 236 may selectively generate read enable signal 238, e.g., if the micro operation of signals 246 is to be operated on one or more source operands stored in source array 234. If the micro operation of signals 246 is to be operated on one or more source values represented by one or more value types maintained by control array 236, then control array 236 may generate signals 248.

Some demonstrative embodiments of the invention, relate to a replacement configuration, e.g., configuration 218, including a value type generator, e.g., generator 220, implemented as part of a RAT, e.g., RAT 216; and a control array, e.g., control array 236, implemented as part of a RS, e.g., RS 232 . However, it will be appreciated by those skilled in the art that other embodiments of the invention may include any other suitable replacement configuration. For example, in some embodiments the replacement configuration may include a value type generator implemented as part of an ID, e.g., ID 208. In these embodiments, the value type generator may be generated, e.g., before providing op-code 210 to RAT 216.

According to some exemplary embodiments of the invention, EU system 250 may generate one or more execution results 262 based on signals 256, 248 and/or 246, as described below.

According to some demonstrative embodiments of the invention, an EU of EU system 250, e.g., EU 274, intended to execute the micro operation of signals 246 may receive signals 246, 248 and/or 256.

According to some demonstrative embodiments of the invention, EU 274 may include a selection configuration 299 including a controller 278, a memory 282, a selector 280, and an Arithmetic Logic Unit (ALU) 284, as are described below.

According to some demonstrative embodiments of the invention, memory 282 may include any suitable memory, e.g., a ROM, able to store a set of one or more source values, e.g., corresponding to the set of one or more value types stored by generator. Memory 282 may generate a signal 286 representing a stored source value corresponding to the value type of signal 248, e.g., based on a signal 288. For example, controller 278 may generate signal 288 corresponding to the value type of signal 248, and memory 282 may include a LUT to generate signal 286 based on the value of signal 288.

According to some exemplary embodiments of the invention, selector 280 may generate one or more signals 290 corresponding to the source operands of signals 256, and/or the stored source value of signal 286, e.g., based on a control signal 289.

According to some demonstrative embodiments of the invention, ALU 284 may include any suitable ALU, e.g., as is known in the art, able to execute the micro operation of signals 246 by operating the micro operation on signals 290.

According to some demonstrative embodiments of the invention, controller 278 may control selector 280, e.g., using signal 289, to generate signals 290 corresponding to the stored source value of signal 286, e.g., if controller 278 receives value type signals 248. Accordingly, EU 274 may execute the micro operation of signals 246 by operating the micro operation on the stored source value of signal 286 corresponding to the value type of signal 248. EU 274 may execute the micro operation of signals 246 by operating the micro operation on one or more source operands of signals 256, e.g., if the source operands of signals 256 do not to correspond to any one of the set of source values, as described above.

In some exemplary embodiments of the invention, one or more of the source operands may have a zero value, e.g., if op-code 246 relates to a single-source operation. In these embodiments, controller 278 may receive value type signals 248 corresponding to the source value zero, and may control selector 280 to generate signals 290 not including the zero source value.

Some demonstrative embodiments of the invention, relate to an EU system, e.g., EU 250, including at least one EU, e.g., EU 274, which includes a selection configuration e.g., selection configuration 299. However, it will be appreciated by those skilled in the art that other embodiments of the invention may relate to an EU system including any suitable configuration. For example, in some embodiments the EUs and the selection configuration may be implemented as separate elements of the EU system.

According to some demonstrative embodiments of the invention, ROB 268 may include any suitable ROB configuration e.g., as is known in the art, able to receive reorder execution results 262 received from execution system 250, e.g., according to the original order of micro operations generated by ID 208. ROB 268 may output the execution results, e.g., as signals 270, to a retired register file of processor core 200; or to RS 232, e.g., as signals 272.

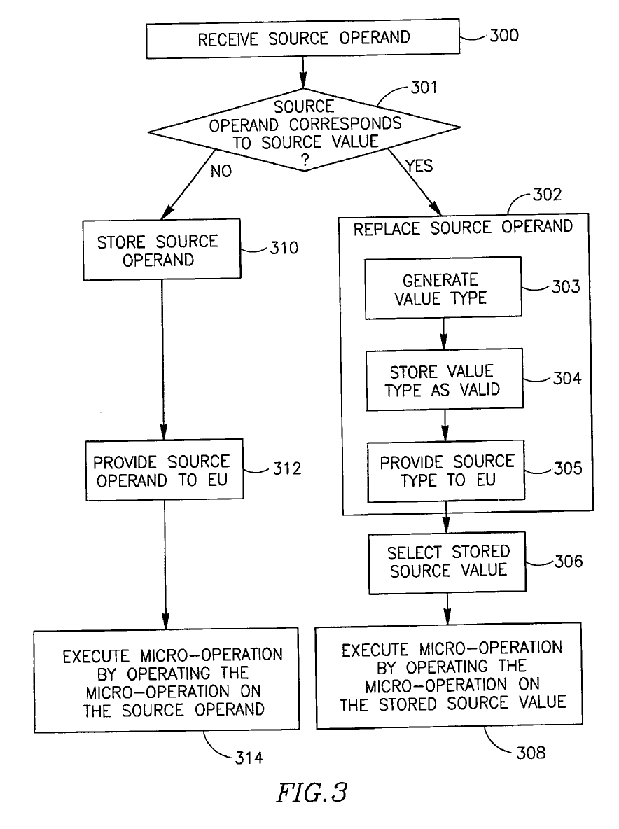

Reference is made to FIG. 3., which schematically illustrates a method of executing a micro operation in accordance with some demonstrative embodiments of the invention.

As indicated at block 300, the method may include receiving a source operand of a micro operation to be executed by an execution unit. The method may also include determining whether the source operand corresponds to the source value, as indicated at block 301.

As indicated at block 302 the method may include replacing the source operand with a value type representing a source value, if the source operand corresponds to the source value. Replacing the source operand may include, for example, using a replacement configuration, e.g., configuration 218 as described above with reference to FIG. 2.

As indicated at block 303, replacing the source operand may include generating the value type. Generating the value type may include, for example, using a value type generator, e.g., generator 220 as described above with reference to FIG. 2.

As indicated at block 304, replacing the source operand may include storing the value type, and identifying the value type as valid, e.g., if the source operand corresponds to the source value. Storing the value type, and identifying the value type as valid, may include, for example, using a control array, e.g., control array 236 as described above with reference to FIG. 2.

As indicated at block 305, the method may include providing the execution unit with the value type, e.g., if the source operand corresponds to the source value. Providing the execution unit with value type may include, for example, using a control array, e.g., control array 236 as described above with reference to FIG. 2.

As indicated at block 306, the method may also include selecting from a set of one or more stored source values a stored source value corresponding to the value type.

As indicated at block 308, the method may also include executing the micro-operation intended to operate on the source operand by operating the micro operation on the stored source value.

As indicated at block 310, the method may include storing the source operand, e.g., if the source operand does not correspond to the source value.

As indicated at block 312, the method may also include providing the execution unit with the source operand.

As indicated at block 314, the method may also include executing the micro-operation by operating the micro operation on the source operand.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention

What is claimed is:

1. A method comprising:
replacing a source operand of a micro operation to be executed by an execution unit with a value type representing a source value, if said source operand corresponds to said source value

2. The method of claim 1, wherein replacing said source operand comprises generating said value type, if said source operand corresponds to said source value.

3. The method of claim 1 comprising:
selecting fiom a set of one or more stored source values a stored source value corresponding to said value type; and
executing said micro-operation by operating said micro operation on said stored source value.

4. The method of claim 1 comprising:
if said source operand corresponds to said source value, storing said value type and identifying said value type as valid.

5. The method of claim 4, wherein storing said value type comprises providing said value type to a control array, and wherein identifying said value type as valid comprises maintaining in said control array a value type identifier identifying said value type as valid.

6. The method of claim 5 comprising transferring said value type from said control array to said execution unit.

7. The method of claim 1 comprising selecting said value type from a set of one or more value types representing a set of one or more source values.

8. The method of claim 1 comprising:
if said source operand does not correspond to said source value, storing said source operand and providing said source operand to said execution unit.

9. The method of claim 8 comprising executing said micro-operation by operating said micro operation on said source operand.

10. An apparatus comprising:
an execution unit to execute a micro-operation; and
a replacement configuration to replace a source operand of said micro operation with a value type representing a source value, if said source operand corresponds to said source value

11. The apparatus of claim 9, wherein said replacement configuration comprises:
a value type generator to generate said value type if said source operand corresponds to said source value; and
a control array to store said value type and to provide said value type to said execution unit.

12. The apparatus of claim 11, wherein said control array is able to maintain a value type identifier identifying said value type as valid.

13. The apparatus of claim 11, wherein said control array is able to transfer said value type to said execution unit.

14. The apparatus of claim 11, wherein said generator is able to select said value type from a set of one or more value types representing a set of one or more source values.

15. The apparatus of claim 11, wherein said generator enables storing said source operand in a data array, and identifies said source operand as valid, if said source operand does not correspond to said source value.

16. The apparatus of claim 15, wherein said control array enables transferring said source operand from said data array to said execution unit, if said source operand is determined not to correspond to said source value.

17. The apparatus of claim 16, wherein said execution unit is able to execute said micro-operation by operating said micro operation on said source operand.

18. The apparatus of claim 10, wherein said execution unit is able to select from a set of one or more stored source values a stored source value corresponding to said value type; and to execute said micro-opetation by operating said micro operation on said stored source value.

19. The apparatus of claim 18, wherein said execution unit comprises a memory to store said set of one or more source values.

20. A computing platform comprising:
a processor including:
an execution unit to execute a micro-operation; and
a replacement configuration to replace a source operand of said micro operation with a value type representing a source value, if said source operand corresponds to said source value; and
a memory associated with said processor and able to store said source operand.

21. The computing platform of claim 20, wherein said replacement configuration comprises:
a value type generator to generate said value type if said source operand corresponds to said source value; and
a control array to store said value type and to provide said value type to said execution unit.

22. The computing platform of claim 20, wherein said execution unit is able to select fiom a set of one or more stored source values a stored source value corresponding to said value type; and to execute said micro-operation by operating said micro operation on said stored source value.
